(19) United States
(12) Patent Application Publication
(10) Pub. No.: US 2012/0238686 A1
(43) Pub. Date: Sep. 20, 2012

(54) THERMOPLASTIC RESIN COMPOSITION AND RESIN MOLDED ARTICLE

(75) Inventors: Makoto NAKAMURA, Kanagawa-ken (JP); Hiroshi Nakano, Kanagawa-ken (JP); Katsuhiro Otsuka, Tokyo (JP); Kazutoyo Matsumura, Osaka-fu (JP)

(73) Assignees: MATSUMURA SANGYO CO., LTD., Osaka-shi (JP); MITSUBISHI ENGINEERING-PLASTIC CORPORATION, Tokyo (JP)

(21) Appl. No.: 13/444,022

(22) Filed: Apr. 11, 2012

Related U.S. Application Data
(63) Continuation-in-part of application No. 12/297,127, filed on Aug. 28, 2009, now Pat. No. 8,178,608.

(30) Foreign Application Priority Data
Apr. 13, 2006 (JP) 2006-111289

(51) Int. Cl. C08L 77/00; C08K 3/34

(52) U.S. Cl. 524/451; 524/538; 524/493

(57) ABSTRACT

The present invention relates to a thermoplastic resin composition which comprises 100 parts by weight of a polyamide resin (component A) and 1 to 400 parts by weight of a granular inorganic filler (component B) comprising an inorganic filler having an average particle diameter of 0.01 to 100 μm and a water-soluble polyester resin binder, and having a bulk density of 0.4 to 1.5 g/mL; and a resin molded article obtained by molding the thermoplastic resin composition. The thermoplastic resin composition is improved in various properties such as extrusion moldability, rigidity, impact resistance, thermal stability and hue, and exhibits an excellent balance between these properties.

### CROSS REFERENCE TO RELATED APPLICATION

This application is a continuation-in-part of application Ser. No. 12/297,127, filed Oct. 14, 2008, which is an International Application No. PCT/JP2007/000360, filed Apr. 3, 2007, which designated U.S. and claims priority of Japanese Application No. 2006-111289, filed Apr. 13, 2006, the entire contents of which are all hereby incorporated herein by reference.

### BACKGROUND OF THE INVENTION

The present invention relates to a thermoplastic resin composition and a resin molded article, and more particularly, to a thermoplastic resin composition comprising a granular inorganic filler which is enhanced in various properties such as extrusion moldability, rigidity, impact resistance, thermal stability and hue, and exhibits an excellent balance between these properties, and a resin molded article obtained by molding the thermoplastic resin composition.

Thermoplastic resins have been used in various extensive applications such as electric, electronic and OA equipments, vehicles, building materials, agricultural materials and sundries because the resins are excellent in various properties such as mechanical properties, electric properties, light weight and moldability. In addition, as the method for improving a rigidity, a strength, dimensional characteristics, etc., of the thermoplastic resins, a method of incorporating inorganic fillers thereinto has been generally and extensively used. In the applications requiring a good appearance, there have been proposed many methods for incorporating small size inorganic fillers such as talc into the resins. Also, in recent years, in the application fields of interior parts, exterior parts and outer plate parts of vehicles as well as various housing members which need to exhibit a good appearance, it has been required that these molded articles have an increased size and a high rigidity. Therefore, as to the impact resistance required for these molded articles, impact characteristics such as a surface impact strength becomes more important rather than Izod impact strength owing to the relation with a strain rate thereof. As a result, it is required to provide a material capable of further improving these impact characteristics by incorporating small size inorganic fillers thereinto.

However, when incorporating the small size inorganic fillers into the thermoplastic resins, there tend to arise problems such as clogging of a hopper, deteriorated extrusion moldability such as poor intrusion into an extruder, and low impact resistance of the resultant resin composition owing to poor dispersion of the inorganic fillers therein. In addition, when incorporating the inorganic fillers into engineering plastics having a high extruding or molding temperature, there tend to arise problems such as deterioration in thermal stability and hue. In particular, in the case where silicate compounds such as talc are incorporated into thermoplastic resin compositions comprising an aromatic polycarbonate resin, adverse influences by decomposition of the resin tend to be remarkably caused, resulting in problems such as deterioration in impact resistance, thermal stability, hue, etc.

Thus, in the application fields of thermoplastic resin compositions into which small size inorganic fillers are incorporated, it has been strongly demanded to develop materials which are excellent in various properties such as extrusion moldability, rigidity, impact resistance, thermal stability and hue. To solve the above conventional problems, there have been proposed, for example, the techniques using, as the small size filler, a talc that is increased in bulk specific gravity by mechanical compression (for example, refer to Japanese Patent Application Laid-Open (KOKAI) Nos. 8-176339 and 10-101914), and the technique using a talc having a specific electric conductivity (for example, refer to Japanese Patent Application Laid-Open (KOKAI) No. 2002-60637). In addition, in the Patent Document 3, it is described that the talc is preferably in the form of a compressed and granulated product, and the talc may be granulated using a binder. However, even when using the techniques specifically described in these Patent documents, the obtained thermoplastic resin compositions are still unsatisfactory in extrusion moldability, thermal stability and impact resistance.

On the other hand, there have been proposed the technique employing a granular inorganic filler that is granulated by using a binder (for example, refer to Japanese Patent Application Laid-Open (KOKAI) No. 2002-220549), and a thermoplastic resin composition obtained by incorporating a granular talc granulated using a specific amount of bentonite, in engineering plastics such as aromatic polycarbonate resins (for example, refer to Japanese Patent Application Laid-Open (KOKAI) No. 2006-77176). However, the thermoplastic resin compositions obtained by incorporating the granular talc granulated by using a binder into engineering plastics such as aromatic polycarbonate resins as described in these Patent Documents, are not necessarily satisfactory in impact resistance, thermal stability and hue.

### SUMMARY OF THE INVENTION

An object of the present invention is to overcome the above problems encountered in the prior art, and provide a thermoplastic resin composition that is improved in various properties such as extrusion moldability, rigidity, impact resistance, thermal stability and hue, and exhibits an excellent balance between these properties, as well as a resin molded article obtained by molding the thermoplastic resin composition.

As a result of the present inventors' earnest study for solving the above conventional problems, it has been found that the thermoplastic resin composition obtained by incorporating a specific granular filler, in particular, a granular inorganic filler granulated by using a water-soluble polyester resin as a binder, into a thermoplastic resin (hereinafter occasionally referred to merely as a “resin composition”), can provide a resin composition that is improved in various properties such as extrusion moldability, rigidity, impact resistance, thermal stability and hue, and exhibits an excellent balance between these properties. The present invention has been attained on the basis of the above finding.

That is, in a first aspect of the present invention, there is provided a thermoplastic resin composition comprising:

100 parts by weight of a polyamide resin (component A); and

1 to 400 parts by weight of a granular inorganic filler (component B) comprising an inorganic filler having an average particle diameter of 0.01 to 100 μm and a water-soluble polyester resin binder, and having a bulk density of 0.4 to 1.5 g/mL.

In a second aspect of the present invention, there is provided a resin molded article produced by molding the above thermoplastic resin composition.

### DETAILED DESCRIPTION OF THE INVENTION

The present invention is described in detail below. However, the following detailed descriptions are concerned with only typical examples of preferred embodiments of the present invention, and not intended to limit the scope of the present invention thereto. Meanwhile, in the present specification, the “group” contained in various compounds involves both substituted and unsubstituted groups, unless departing from the scope of the present invention.

### Thermoplastic Resin (Component A):

Examples of the thermoplastic resin used as the component A in the present invention (hereinafter occasionally referred to merely as the “component A”) include polyamide resins such as polyamide-6 and polyamide-6,6. These polyamide resins may be used alone or in combination of any two or more thereof.

The polyamide resin used in the present invention has a —CO—NH— bond in a polymer main chain thereof, and is capable of being melted under heating. As the polyamide resin, there may be used polymers of lactams having 3 or more-membered ring, polymers of polymerizable ω-amino acids, or those polyamide resins obtained by polycondensing a dibasic acid with a diamine, etc. Specific examples of the polyamide resin include polymers of ε-caprolactam, amino-caproic acid, enanthlactam, 7-amino-heptanoic acid, 11-amino-undecanoic acid, 9-amino-nonanoic acid, α-pyrrolidone and α-piperidone; and polymers or copolymers obtained by polycondensing a diamine such as hexamethylenediamine, nonamethylenediamine, undecamethylenediamine, dodecamethylenediamine and m-xylylenediamine with a dibasic acid such as terephthalic acid, isophthalic acid, adipic acid, sebacic acid, dodecanedioic acid and glutaric acid.

Typical examples of the polyamide resin include polymers such as polyamide-4, polyamide-6, polyamide-12, polyamide-6.6, polyamide-4.6, polyamide-6T and polyamide-MXD6; and copolymers such as polyamide-6/6.6, polyamide-6/12, polyamide-6/6T and polyamide-6T/6I. In the present invention, a plurality of these polyamide resins may be used in combination. Among these polyamide resins, preferred are polyamide-6, polyamide-6.6 and polyamide-MXD6 which may be used in combination with polyamide-6/6.6 or polyamide-6T/6I.

The polyamide resin used in the present invention preferably has a relative viscosity of 2 to 7 and more preferably 2.2 to 5 as measured at 23° C. in a 98% by weight concentrated sulfuric acid by adjusting a concentration of the polyamide resin therein to 1% by weight. As to the concentrations of end groups of the polyamide resin, the end carboxyl group content therein is preferably not more than 100 μeq/g, and the ratio of the end carboxyl group content to the end amino group content (end carboxyl group content/end amino group content) therein is preferably 0.8 to 4. When the ratio of the end carboxyl group content/end amino group content is less than 0.8, the resultant composition tends to be insufficient in fluidity, while when the ratio of the end carboxyl group content/end amino group content is more than 4, the resultant composition tends to be insufficient in impact resistance.

### Granular Talc (Component B):

The granular inorganic filler as the component B used in the present invention (hereinafter occasionally referred to merely as the “component B”) is such a granular inorganic filler which is obtained from an inorganic filler having an average particle diameter of 0.01 to 100 μm and a water-soluble polyester resin binder, and has a bulk density of 0.4 to 1.5 g/mL.

The average particle diameter of the inorganic filler as the raw material of the granular inorganic filler used in the present invention is preferably 0.01 to 100 μm, more preferably 0.05 to 50 μm and still more preferably 0.1 to 25 μm. When the average particle diameter of the inorganic filler is too small, the reinforcing effect of the resultant granular inorganic filler tends to be unsatisfactory, while when the average particle diameter of the inorganic filler is too large, the obtained resin molded article tends to be adversely affected in appearance thereof and further tends to be insufficient in impact resistance. Therefore, the average particle diameter of the inorganic filler is more preferably 0.2 to 15 μm and still more preferably 0.3 to 10 μm. The average particle diameter as used herein means D₅₀ measured by a liquid phase precipitation method using X-ray transmission. The measurement of D₅₀ may be carried out, for example, by using a Sedigraph particle size analyzer “Model 5100” manufactured by Micromeritics Instruments Corp.

Examples of the inorganic filler as the raw material of the granular inorganic filler used in the present invention include silicate compounds such as wollastonite, talc, mica, zonotlite, sepiolite, attapulgite and kaolinite; composite oxides such as potassium titanate, titanium oxide, alumina oxide and zinc oxide; carbonate compounds such as calcium carbonate; sulfate compounds such as barium sulfate and calcium sulfate; carbon-based fillers such as graphite and carbon black; silica; glass-based fillers such as glass flakes and glass beads; and aluminum borate. These inorganic filers may be used alone or in combination of any two or more thereof.

Among the granular inorganic fillers used in the present invention, from the viewpoints of a good balance between rigidity, fluidity, impact resistance and appearance of the obtained product, preferred are granular silicate compounds such as wollastonite, talc, mica, zonotlite, sepiolite, attapulgite and kaolinite. In particular, the granular talc is more preferably used as the granular inorganic filler.

The granular talc as the granular inorganic filler (component B) used in the present invention is a hydrous magnesium silicate having a layer structure which is represented by the chemical formula: 4SiO₂.3MgO.H₂O and usually comprises 58 to 66% by weight of SiO₂, 28 to 35% by weight of MgO and about 5% by weight of H₂O. The granular talc may also comprise, as the other trace components, 0.03 to 1.2% by weight of Fe₂O₃, 0.05 to 1.5% by weight of Al₂O₃, 0.05 to 1.2% by weight of CaO, not more than 0.2% by weight of K₂O, not more than 0.2% by weight of Na₂O, etc., and has a specific gravity of about 2.7.

In addition, the granular inorganic filler (component B) used in the present invention is preferably subjected to surface treatment in order to enhance an affinity to the resin as the component A, etc. Specific examples of the surface-treating agent include alcohols such as trimethylol ethane, trimethylol propane and pentaerythritol; alkanol amines such as triethylamine; organic silicone-based compounds such as organopolysiloxanes; higher fatty acids such as stearic acid; fatty acid metal salts such as calcium stearate and magnesium stearate; hydrocarbon-based lubricants such as polyethylene wax and liquid paraffin; basic amino acids such as lysine and alginine; polyglycerol and derivatives thereof; and coupling agents such as silane-based coupling agents, titanate-based coupling agents and aluminum-based coupling agents.

Next, the water-soluble polyester resin as the binder used for forming the granular inorganic filler (component B) used in the present invention by granulation is explained. The water-soluble polyester resin means a copolymer obtained by subjecting a dicarboxylic acid component comprising a dicarboxylic acid or a reactive derivative thereof, a diol component comprising a diol or an ester derivative thereof and a water-solubility imparting component as main raw materials, to condensation reaction, which exhibits a good solubility in water. The solubility of the copolymer in water may be appropriately determined and may be controlled by varying a content of the water-solubility imparting component.

The dicarboxylic acid used as the raw material of the water-soluble polyester resin may be in the form of either an aromatic dicarboxylic acid or an aliphatic dicarboxylic acid. From the viewpoints of a good heat resistance of the resultant resin composition, etc., the aromatic dicarboxylic acid is preferred. Specific examples of the aromatic dicarboxylic acid include terephthalic acid, isophthalic acid, orthophthalic acid, 1,5-naphthalenedicarboxylic acid, 2,6-naphthalenedicarboxylic acid, 4,4′-biphenyl dicarboxylic acid, 4,4′-biphenylether dicarboxylic acid, 4,4′-biphenylmethane dicarboxylic acid, 4,4′-biphenylsulfone dicarboxylic acid, 4,4′-biphenylisopropylidene dicarboxylic acid, 1,2-bis(phenoxy)ethane-4,4′-dicarboxylic acid, 2,5-anthracene dicarboxylic acid, 2,6-anthracene dicarboxylic acid, 4,4′-p-terphenylene dicarboxylic acid, and 2,5-pyridine dicarboxylic acid. Further, there may also be used substituted products of these acids (for example, alkyl-substituted products such as 5-methylisophthalic acid) or reactive derivatives of these acids (for example, alkyl ester derivatives such as dimethyl terephthalate and diethyl terephthalate).

Among these aromatic dicarboxylic acids, preferred are terephthalic acid, isophthalic acid, 2,6-naphthalene dicarboxylic acid and alkyl ester derivatives of these acids. These aromatic dicarboxylic acids may be use alone or in combination of any two or more thereof. In addition, the aromatic dicarboxylic acids may be used in combination with one or more acids selected from the group consisting of aliphatic dicarboxylic acids such as adipic acid, azelaic acid, sebacic acid, dodecanedioic acid, and alicyclic dicarboxylic acids such as cyclohexane dicarboxylic acid.

Examples of the diol used as the raw material of the water-soluble polyester resins include aliphatic diols such as ethylene glycol, 1,2-propylene glycol, 1,3-propanediol, 1,4-butanediol, neopentyl glycol, 1,5-pentanediol, 1,6-hexanediol, decamethylene glycol and 2,2-dimethyl-1,3-propanediol; alicyclic diols such as 1,4-cyclohexane dimethanol, 1,3-cyclohexane dimethanol, cyclohexanediol and trans- or cis-2,2,4,4-tetramethyl-1,3-cyclobutanediol; aromatic diols such as p-xylenediol, bisphenol A, tetrabromobisphenol A and tetrabromobisphenol A-bis(2-hydroxyethyl ether); and substituted product of these compounds.

Among these diols, from the viewpoint of a good heat resistance of the resultant resin composition, preferred are ethylene glycol, 1,3-propanediol, 1,4-butanediol and 1,4-cyclohexane dimethanol, more preferred are ethylene glycol, 1,3-propanediol and 1,4-butanediol, and most preferred is ethylene glycol. These diols may be used alone or in combination of any two or more thereof. Further, as the diol component, one or more long-chain diol having a molecular weight of 400 to 6000 such as polyethylene glycol, poly-1,3-propylene glycol and polytetramethylene glycol, may also be used in combination with the above diols, and both may be copolymerized with the dicarboxylic acid component.

Examples of the water-solubility imparting component used as the raw material of the water-soluble polyester resin include dicarboxylic acids having a metal sulfonate group, and polyethylene glycol. Among these compounds, from the viewpoint of a good heat resistance, preferred are dicarboxylic acids having a metal sulfonate group.

Examples of the dicarboxylic acids having a metal sulfonate group include alkali metal salts such as sodium salts and potassium salts of 5-sulfo-isophthalic acid, 2-sulfo-isophthalic acid, 4-sulfo-isophthalic acid, sulfo-terephthalic acid, 4-sulfo-naphthalene-2,6-dicarboxylic acid, etc., and ester-forming derivatives of these salts. Among these compounds, from the viewpoint of a good water solubility, preferred are sodium 5-sulfo-isophthalate and ester derivatives thereof.

When the content of the dicarboxylic acid having a metal sulfonate group is too small, the resultant polyester resin tends to be insufficient in water solubility. On the other hand, when the content of the dicarboxylic acid having a metal sulfonate group is too large, the resultant water-soluble polyester resin tends to be insufficient in heat resistance. Therefore, the content of the dicarboxylic acid having a metal sulfonate group in the water-soluble polyester resin is preferably 1 to 40 mol % and more preferably 5 to 35 mol % on the basis of the whole carboxylic acid component as the raw material of the water-soluble polyester resin.

Specific examples of the suitable water-soluble polyester resin as the binder for forming the granular inorganic filler (component B) used in the present invention include copolymers obtained from terephthalic acid, ethylene glycol and sodium 5-sulfo-isophthalate. Examples of commercially available products of the water-soluble polyester resin include “PLUSCOAT Z-221”, “PLUSCOAT Z-561” and “PLUSCOAT Z-446” all produced by Go-Oh Kagaku Kogyo Co., Ltd., etc.

The content of the water-soluble polyester resin binder in the granular inorganic filler (component B) used in the present invention may be appropriately selected and determined, and is preferably 0.01 to 5% by weight on the basis of 100% by weight of the granular inorganic filler (component B). When the content of the binder is not less than 0.01% by weight, the granular talc tends to be hardly broken, and the resultant resin composition tends to be further enhanced in various properties, specifically, extrusion moldability, rigidity, impact resistance and thermal stability. On the other hand, when the content of the binder is not more than 5% by weight, the granular inorganic filler as the component B used in the present invention, in particular, granular talc, tends to exhibit a good dispersibility in the resin composition, and the resultant resin composition tends to be further enhanced in appearance of a molded article obtained therefrom as well as impact resistance.

Therefore, the content of the water-soluble polyester resin binder in the granular inorganic filler (component B) used in the present invention is more preferably 0.05 to 3.5% by weight and still more preferably 0.1 to 3% by weight.

The granular inorganic filler (component B) used in the present invention has a bulk density of 0.4 to 1.5 g/mL. When using the granular inorganic filler having a bulk density of not less than 0.4 g/mL, the resultant resin composition of the present invention tends to be further enhanced in various properties, specifically, extrusion moldability, rigidity, impact resistance and thermal stability. On the other hand, when using the granular inorganic filler having a bulk density of not more than 1.5 g/mL, the resultant resin composition tends to be further enhanced in appearance of a molded article obtained therefrom as well as impact resistance. Therefore, the bulk density of the granular inorganic filler (component B) used in the present invention is preferably 0.5 to 1.3 g/mL and more preferably 0.6 to 1.1 g/mL.

The bulk density as used herein means the value measured by the following methods (1) to (3).

(1) The granular inorganic filler is placed on a screen having a mesh size of 1.4 mm and allowed to pass therethrough while lightly uniformly sweeping with a brush.

(2) The granular inorganic filler passed through the screen is charged into a receptacle fitted to a bulk density measuring apparatus prescribed in JIS K5101 until heaping up the receptacle with the granular inorganic filler.

(3) An upper portion of the granular inorganic filler heaped up in the receptacle is wiped off using a spatula through an inlet of the receptacle to measure a weight of the granular inorganic filler in the receptacle and calculate a bulk density of the granular inorganic filler according to the following formula.

Bulk density(g/mL)=(weight(g)of granular inorganic filler in receptacle)/(capacity(mL)of receptacle)

The granular inorganic filler (component B) used in the present invention has such a particle size that a proportion of a 500 μm-mesh screen residue thereof is not less than 55% by weight, preferably not less than 60% by weight, more preferably not less than 70% by weight and still more preferably not less than 90% by weight. When using the granular inorganic filler having such a particle size in which a proportion of a 500 μm-mesh screen residue thereof is not less than 55% by weight, the resultant resin composition tends to be further enhanced in impact resistance and thermal stability.

The particle size of the granular inorganic filler (component B) used in the present invention is the value measured by the following methods (1′) to (3′) according to JIS Z8801.

(1′) The granular inorganic filler is placed on a screen having a mesh size of 2 mm and allowed to pass therethrough while lightly uniformly sweeping with a brush.

(2′) The granular inorganic filler passed through the screen is fully charged into a 200 mL beaker, and subjected to sample reduction using a sample reduction device “1305 No. 6” (groove width: 6 mm) manufactured by Yoshida Seisakusho Co., Ltd., until the amount of the granular inorganic filler is reduced to about 30 mL.

(3′) Using a screen having a mesh size of 500 μm, the granular inorganic filler thus subjected to sample reduction is sieved therethrough to determine a weight of the granular inorganic filler not passed through the 500 μm-mesh screen (screen residue; oversize) and calculate a proportion of the non-passed granular inorganic filler by dividing the thus measured weight by a whole weight of the granular inorganic filler. Meanwhile, the sieving procedure is carried out at a frequency of 120 cycles/sec for 10 min using an electromagnetic sieve “M-100 Type” manufactured by Tsutsui Rikagaku Kiki Co., Ltd.

The size and shape of the granular inorganic filler (component B) used in the present invention are optional, and may be appropriately selected and determined from various shapes and sizes such as a bar shape, a cylindrical shape, a needle-like shape, a spherical shape, a granular shape, a flake-like shape and an amorphous shape by controlling molding conditions and granulating conditions depending upon the applications thereof. The method for producing the granular inorganic filler is also optional. More specifically, for example, in the case where the bar-shaped or cylindrical granular inorganic filler is to be produced, the axis diameter of the granular inorganic filler may be appropriately adjusted by varying a mesh size of a screen used in a screen-type extrusion molding machine, and the thus molded article may be granulated and then cut into a desired axis length.

The size of the granular inorganic filler (component B) used in the present invention is not particularly limited as long as the bulk density thereof lies within the above specified range. However, when dispersed in a melting kneader or a molding machine, it is more advantageous that the size of the granular inorganic filler is smaller than that of resin pellets used upon melt-kneading or molding. For example, the bar-shaped or cylindrical granular inorganic filler preferably has an average axis diameter of 0.2 to 6 mm and an average axis length of 2 to 6 mm and more preferably a ratio of an average axis diameter to an average axis length of 1:0.5 to 1:2.

The method (granulating method) for producing the granular inorganic filler (component B) used in the present invention is optional, and the granular inorganic filler may be produced by any conventionally known granulating methods. In order to enhance a kneading property between the inorganic filler and the water-soluble polyester resin binder as the raw materials, impart a good plasticity to the obtained kneaded material upon production of the granules, realize a facilitated production, reduce abrasion in a granulator, and further control a hardness of the resultant granules, it is preferred to add a wetting agent to the inorganic filler and binder.

Usually, a lubricant is added to the inorganic filler and the water-soluble polyester resin, if required, together with a dispersant and other additives, and these components are mixed with each other while stirring using a mixer such as a Henschel mixer and a super-mixer, thereby obtaining a mixture of these components. The thus obtained mixture is kneaded using a screw-type extruder such as a single-screw extruder and a twin-screw extruder, and then extruded therefrom into strands. The extruded strands are cut and granulated, and then dried using a fluidized type dryer or a band heater, thereby obtaining the granular inorganic filler. After drying, the resultant granules may be subjected to classification.

Examples of the lubricant used in the present invention include water, organic solvents, etc. Among these lubricants, from the viewpoints of a low price and a good working efficiency, preferred is water. When using water, a mixture of water and an alcohol may be used. In addition, a water-soluble polyester resin may be previously dissolved or suspended in water. Further, if required, various additives such as, for example, a dispersant, a surfactant, various additives for synthetic resins, dyes, pigments, etc., may be dissolved or suspended in water in order to further enhance a uniformity of the resultant granules.

When using water as the lubricant, the water content in the resultant granular inorganic filler (component B) is preferably controlled to not more than 1% and more preferably not more than 0.5% by drying the granular inorganic filler using a fluidized bed dryer, etc., to remove water therefrom. The drying temperature may be appropriately selected, and is usually 80 to 150° C. and preferably 80 to 110° C.

The amount of the lubricant used may be appropriately determined. However, when the amount of the lubricant used is too small, the effect of addition of the lubricant tends to be insufficient, whereas when the amount of the lubricant used is too large, excessive time and energy tend to be required for removal of the lubricant. Therefore, the amount of the lubricant used is 10 to 150 parts by weight, preferably 15 to 100 parts by weight and more preferably 20 to 60 parts by weight on the basis of 100 parts by weight of a total amount of the inorganic filler and the water-soluble polyester resin as the raw materials of the granular inorganic filler (component B) used in the present invention.

Further, in the present invention, a dispersant may be incorporated in the granular inorganic filler (component B) in order to enhance a dispersibility thereof in resin compositions and resin molded articles. The content of the dispersant in the granular inorganic filler (component B) may be appropriately determined, and is usually 0.05 to 2.0% by weight and preferably 0.1 to 0.5% by weight.

The dispersant used in the present invention may be optionally selected from conventionally known ones. Specific examples of the dispersant include the above-mentioned alcohols, alkanol amines, organic silicone-based compounds, higher fatty acids, fatty acid metal salts, hydrocarbon-based lubricants, basic amino acids, polyglycerol, and derivatives thereof. In the present invention, there may be used one or more dispersants selected from these compounds. In addition, the above surface-treated inorganic filler may be used as the inorganic filler as the raw material of the granular inorganic filler (component B), and further the dispersant may be added thereto and then the resultant mixture may be granulated to obtain the granular inorganic filler (component B) used in the present invention.

Further, in addition to the dispersant, various other additives may be added, if required, to the granular inorganic filler (component B) used in the present invention unless the addition of these additives adversely affects the features or effects of the present invention. Specific examples of the additives include various antioxidants such as hindered phenol-based compounds, various heat stabilizers such as phosphite-based compounds, various ultraviolet absorbers such as benzotriazole-based compounds, benzophenone-based compounds and triazine-based compounds, various flame retardants such as phosphate-based compounds, silicone-based compounds and metal salt-based compounds, various release agents such as olefin waxes and fatty acid ester-based compounds, antibacterial agents and mildew-proof agents such as phenol-based compounds, antistatic agents such as anionic, cationic or nonionic compounds, colorants, light stabilizers, plasticizers, and foaming agents. These additives may also be used in the form of a blended mixture of plural kinds thereof.

### Other Components:

The thermoplastic resin composition of the present invention may also comprise various additives for resins, if required, unless the addition of these additives adversely affects the aimed effects of the present invention. Examples of the additives for resins include rubber polymers, phosphorus-based compounds, antioxidants, release agents, ultraviolet absorbers, dyes and pigments, flame retardants, dropping inhibitors, antistatic agents, antifogging agents, lubricants, anti-blocking agents, fluidity improvers, plasticizers, dispersants and antibacterial agents. These additives may be used in combination of any two or more thereof.

### Process for Production of Thermoplastic Resin Composition:

The process for producing the thermoplastic resin composition of the present invention is optional, and may be appropriately selected from conventionally known optional methods for production of thermoplastic resin compositions. More specifically, the thermoplastic resin composition of the present invention may be produced by the method of previously mixing the above components A and B, if required, various other additives, with each other, using various mixers such as a tumbler and a Henschel mixer, and then melt-kneading the resultant mixture using a Banbury mixer, a roll, a Brabender, a single-screw kneading extruder, a twin-screw kneading extruder, a kneader, etc.

Alternatively, the respective components may be directly fed without being previously mixed, or may be fed after previously mixing only a part of the components, to the extruder through a feeder, and then melt-kneaded, thereby producing the resin composition. This method allows the component B to be fed without being previously mixed with the other components to the extruder through the feeder and melt-kneaded therewith in the extruder to produce the resin composition. Therefore, such a method is preferred from the viewpoint of extrusion molding workability because deterioration in working environmental conditions due to occurrence of scattering or dusting of the granular inorganic filler can be avoided. Further, if the component B is such a granular inorganic filler that tends to readily incur breakage of fibers when melt-kneaded, from the viewpoint of good mechanical properties of the resultant resin composition, there may be suitably used such a method in which the components other than the component B are fed into the extruder at one time on an upstream side portion thereof, and thereafter the component B is fed subsequent to the midstream portion thereof and then melt-kneaded together with the resin components fed previously.

### Production of Resin Molded Article:

The process for producing a resin molded article of the present invention is optional, and may be appropriately selected from any conventionally known resin molding methods. More specifically, the resin molded article may be produced, for example, by various ordinary resin molding methods such as an injection molding method, an ultrahigh-speed injection molding method, an injection compression molding method, a two-color molding method, a blow molding method such as a gas-assisted blow molding method, a molding method using an insulated runner mold, a molding method using a rapidly heating mold, an expansion molding method (including supercritical fluid), an insert molding method, an IMC (in-mold coating) molding method, an extrusion molding method, a sheet molding method, a thermoforming method, a rotational molding method, a lamination molding method and a press molding method. In addition, there may also be adopted such a molding method using a hot runner.

Further, in the present invention, from the viewpoints of less amount of wastes, reduction in environmental burden and low costs, upon producing the resin molded article from the resin composition, the virgin material may be mixed with recycled raw materials such as nonconforming products, sprues, runners and used products in order to realize recycling of materials (so-called material-recycling). In this case, the recycled raw materials used are preferably crushed or pulverized to prevent occurrence of defects upon producing the molded article. The content of the recycled raw materials in the molded article is usually not more than 70% by weight, preferably not more than 50% by weight and more preferably not more than 30% by weight on the basis of a total amount of the recycled raw materials and the virgin material.

The thermoplastic resin composition according to the present invention is characterized by being improved in various properties such as extrusion moldability, rigidity, impact resistance, thermal stability and hue, and exhibiting an excellent balance between these properties. The thermoplastic resin composition having the above advantages can be used in various extensive applications. Examples of the applications of the thermoplastic resin composition according to the present invention include parts of electric and electronic equipments, parts of OA equipments, mechanical parts, vehicle parts, building members, various containers, leisure goods, sundries, various housings for cellular phones, etc. In particular, the thermoplastic resin composition according to the present invention can also be suitably used as exterior parts, outside plate parts and interior parts for vehicles.

Specific examples of the exterior parts and outside plate parts for vehicles include outer door handles, bumpers, fenders, door panels, trunk lids, front panels, rear panels, roof panels, bonnets, pillars, side moldings, garnishes, wheel caps, hood bulges, fuel lids, various spoilers, and cowlings of motorcycles. Specific examples of the interior parts for vehicles include inner door handles, center panels, instrument panels, console boxes, luggage floor boards, and housings of displays for car navigation, etc.

### EXAMPLES

The present invention is described in more detail below by the following Examples. However, these Examples are only illustrative and not intended to limit a scope of the present invention. Meanwhile, in the following examples and comparative examples, the amounts of the respective components blended mean “part(s) by weight”.

The following raw materials were prepared upon producing the respective resin compositions in Examples and Comparative Examples. Meanwhile, the relative viscosity was measured at 23° C. in a 98% by weight concentrated sulfuric acid by controlling the concentration of the resin composition therein to 1% by weight.

### <Polyamide Resin>

Polyamide-6 (1): “NOVAMIDE 1020J” produced by Mitsubishi Engineering-Plastics Corporation; relative viscosity: 3.5; ratio of end carboxyl group content/end amino group content: 1.0

Polyamide-6 (2): “NOVAMIDE 1010J” produced by Mitsubishi Engineering-Plastics Corporation; relative viscosity: 2.5; ratio of end carboxyl group content/end amino group content: 2.6

### Granular Inorganic Filler

### Granular Talc (1)

### Production Example 1

A 20 L Henschel mixer was charged with 4000 g of talc (“HIGH-FILLER #5000PJ” produced by Matsumura Sangyo Co., Ltd.) having an average particle size of 1.8 μm, and then 100 g of a water-soluble polyester aqueous solution comprising 20% by weight of a water-soluble polyester resin obtained from terephthalic acid, ethylene glycol and sodium 5-sulfo-isophthalate (“PLUSCOAT Z-221” produced by Go-Oh Kagaku Kogyo Co., Ltd.) and 1520 g of clean water were added thereinto over 2 min while stirring the contents of the mixer at a high speed by operating an agitation blade at 1500 rpm. After adding the aqueous solution, the resultant mixture was further continuously stirred for 3 min, thereby obtaining a clay-like kneaded material.

Next, the thus obtained kneaded material was extruded and granulated using a roll basket type granulating apparatus equipped with a 1.2 mm-mesh screen, and then dried using a fluidized bed dryer at a hot air temperature of 100° C. for about 60 min, thereby obtaining a granular talc. Further, the particle size of the granular talc was uniformed using a granulator, thereby obtaining cylindrical granules having an average axis diameter of 1.2 mm and an average axis length of 1.5 mm (hereinafter referred to merely as the “granular talc (1)”). As a result, it was confirmed that the thus obtained granular talc (1) had a content of the water-soluble polyester resin of 0.5% by weight, a bulk density of 0.70 g/mL, a 500 μm-mesh screen residue (as a particle size) of 95% by weight and a water content of 0.2%.

### Granular Talc (2)

### Production Example 2

The granulating procedure was conducted in the same manner as defined in Production Example 1 except that the water-soluble polyester aqueous solution (Z-221) and the clean water were used in amounts of 200 g and 1440 g, respectively, thereby obtaining a granular talc (2). As a result, it was confirmed that the thus obtained granular talc (2) had a content of the water-soluble polyester resin of 1% by weight, a bulk density of 0.70 g/mL, a 500 μm-mesh screen residue (as a particle size) of 98% by weight and a water content of 0.4%.

### Granular Talc (3)

### Production Example 3

The granulating procedure was conducted in the same manner as defined in Production Example 1 except that a water-soluble polyester aqueous solution comprising 25% by weight of a water-soluble polyester resin obtained from terephthalic acid, ethylene glycol and sodium 5-sulfo-isophthalate (“PLUSCOAT Z-561” produced by Go-Oh Kagaku Kogyo Co., Ltd.) and clean water were used in amounts of 80 g and 1540 g, respectively, thereby obtaining a granular talc (3). As a result, it was confirmed that the thus obtained granular talc (3) had a content of the water-soluble polyester resin of 0.5% by weight, a bulk density of 0.68 g/mL, a 500 μm-mesh screen residue (as a particle size) of 94% by weight and a water content of 0.3%.

### <Granular Inorganic Fillers for Comparative Examples>

Granular talc (4): “MTB-12” produced by Matsumura Sangyo Co., Ltd.; average particle size of talc: 1.8 μm; bulk density: 0.74 g/mL; 500 μm-mesh screen residue (as a particle size): 98% by weight; particle shape: cylindrical; average axis diameter: 1.2 mm; average axis length: 1.5 mm; kind of binder: CMC (“CELOGEN 7A” produced by Dai-Ichi Kogyo Seiyaku Co., Ltd.); content of binder: 0.3% by weight; content of water as lubricant: 0.11%

Granular talc (5): “MTB-11” produced by Matsumura Sangyo Co., Ltd.; average particle size of talc: 1.8 μm; bulk density: 0.72 g/mL; 500 μm-mesh screen residue (as a particle size): 97% by weight; particle shape: cylindrical; average axis diameter: 1.2 mm; average axis length: 1.5 mm; kind of binder: second-class glue (JIS K6503, “AGX-5195B” produced by Nitta Gelatin Co., Ltd.); content of binder: 0.5% by weight; content of water as lubricant: 0.12%

Granular talc (6): “MTB-5” produced by Matsumura Sangyo Co., Ltd.; average particle size of talc: 1.8 μm; bulk density: 0.69 g/mL; 500 μm-mesh screen residue (as a particle size): 92% by weight; particle shape: cylindrical; average axis diameter: 1.2 mm; average axis length: 1.5 mm; kind of binder: bentonite; content of binder: 0.5% by weight; content of water as lubricant: 0.15%

### <Inorganic Fillers for Comparative Examples>

Powdery talc: “HIGH-FILLER #5000PJ” produced by Matsumura Sangyo Co., Ltd.; average particle size: 1.8 μm; bulk density: 0.12 g/mL; 500 μm-mesh screen residue (as a particle size): 0% by weight

Compressed talc: “UPN HS-T0.8” produced by Hayashi Kasei Co., Ltd.; degassed compressed product; average particle size: 2 μm; bulk density: 0.8 g/mL; 500 μm-mesh screen residue (as a particle size): 32% by weight

### Production of Resin Composition and Production of Test Specimen

### Examples 1 to 3 and Comparative Examples 1 to 5

The respective components as shown in Table 1 were uniformly mixed at the proportions shown in the same Table with each other using a tumbler mixer. Then, the resultant mixture was fed to a twin-screw extruder “TEX30XCT” (L/D=42; number of barrels: 12) manufactured by Nippon Seikosho Co., Ltd., through a barrel 1 thereof, melt-kneaded therein at a cylinder temperature of 250° C. and a screw rotating speed of 300 rpm, and extruded therefrom, thereby obtaining a resin composition in the form of pellets.

The pellets obtained from the above-produced resin composition were dried at 120° C. for 6 hr or longer, and then molded using an injection molding machine “M150AII-SJ Model” manufactured by Meiki Seisakusho Co., Ltd., at a cylinder temperature of 250° C., a mold temperature of 80° C. and a molding cycle time of 55 sec, thereby producing an ASTM test specimen and a 100 mmφ disc-shaped molded article (having a thickness of 3 mm).

### <Evaluation Methods>

### (1) Extrusion Moldability

The extrusion moldability upon producing the resin composition was evaluated according to the following ratings.

◯: Strands and pellets were readily produced with an extrusion output of not less than 40 k/h without problems such as clogging of a hopper and defective intrusion into an extruder.

X: Problems such as clogging of a hopper and defective intrusion into an extruder occurred, and strands and pellets were not produced unless reducing an extrusion output.

### (2) Rigidity (Bending Modulus)

According to ASTM D790, a test specimen having a thickness of 6.4 mm was tested to measure a bending modulus thereof (unit: MPa) at 23° C.

### (3) Impact Resistance:

### a: Izod Impact Strength:

According to ASTM D256, a notched test specimen having a thickness of 3.2 mm was tested to measure an Izod impact strength thereof (unit: J/m) at 23° C.

### b: Surface Impact Strength:

The disc-shaped molded article (ordinary molded article) produced above was subjected to impact test in which the molded article was punched at a punch diameter of ½ inch, a support diameter of 3 inch and a punching speed of 1 m/s using a high-rate impact tester (manufactured by Shimadzu Seisakusho Co., Ltd.). The larger the surface impact strength (breaking energy; unit: J), the more excellent the impact resistance.

### (4) Hue:

The disc-shaped molded article (ordinary molded article) produced above was subjected to measurement of YI value thereof by a reflection method (retainer plate: white plate) using a spectro-colorimeter “SE 2000 Model” manufactured by Nippon Denshoku Kogyo Co., Ltd. The smaller the YI value, the more excellent the hue.

### Example 1 to 3 and Comparative Examples 1 to 5

The respective resin compositions shown in Tables 1 to 5 were produced and evaluated by the above methods. The results are shown in Table 1.

TABLE 1

| | Examples | | | Comparative Examples | | | | |
|---|---|---|---|---|---|---|---|---|
| | 1 | 2 | 3 | 1 | 2 | 3 | 4 | 5 |
| Composition (wt. | | | | | | | | |
| part) | | | | | | | | |
| Polyamide-6 resin | 50 | 50 | 50 | 50 | 50 | 50 | 50 | 50 |
| (1) | | | | | | | | |
| Polyamide-6 resin | 50 | 50 | 50 | 50 | 50 | 50 | 50 | 50 |
| (2) | | | | | | | | |
| Granular talc (1) | 25 | — | — | — | — | — | — | — |
| Granular talc (2) | — | 25 | — | — | — | — | — | — |
| Granular talc (3) | — | — | 25 | — | — | — | — | — |
| Granular talc (4) | — | — | — | 25 | — | — | — | — |
| Granular talc (5) | — | — | — | — | 25 | — | — | — |
| Granular talc (6) | — | — | — | — | — | 25 | — | — |
| Powdery talc | — | — | — | — | — | — | 25 | — |
| Compressed talc | — | — | — | — | — | — | — | 25 |
| Evaluation results | | | | | | | | |
| Extrusion | ◯ | ◯ | ◯ | ◯ | ◯ | ◯ | X | X |
| moldability | | | | | | | | |
| Rigidity: Bending | 5340 | 5330 | 5310 | 5320 | 5290 | 5330 | 5200 | 5230 |
| modulus (MPa) | | | | | | | | |
| Impact | | | | | | | | |
| resistance: | | | | | | | | |
| Izod impact | 48 | 47 | 48 | 39 | 39 | 40 | 35 | 33 |
| strength (J/m) | | | | | | | | |
| Surface impact | 15 | 16 | 15 | 8 | 7 | 9 | 5 | 4 |
| strength (J) | | | | | | | | |
| Hue: YI value | 4.5 | 4.2 | 4.4 | 19.3 | 27.3 | 10.3 | 6.5 | 6.4 |

From the results of Examples and Comparative Examples shown in Table 1, the followings were confirmed. The resin compositions obtained in Examples 1 to 3 according to the present invention were excellent in extrusion moldability, rigidity, impact resistance and hue. On the other hand, the resin compositions obtained in Comparative Examples 1 to 5 in which the content of the component B was out of the specific range defined by the present invention were deteriorated in impact resistance and hue, and further the resin compositions obtained in Comparative Examples 4 and 5 were also deteriorated in extrusion moldability.

Although the present invention is described above with respect to embodiments which are considered to be most practical and preferable at the present time, the present invention is not limited to these embodiments described in the present specification, and various changes and modifications will be appropriately made within the scope of claims and a whole description of the present specification unless departing from the subject matter and concept of the present invention, and it should be construed that these changes and modifications are involved in the technical scope of the present invention. Meanwhile, the present patent application is based on Japanese Patent Application (No. 2006-111289) filed on Apr. 13, 2006, the entire contents of which are incorporated herein by reference thereto.

What is claimed is:

1. A thermoplastic resin composition comprising:
100 parts by weight of a polyamide resin (component A); and
1 to 400 parts by weight of a granular inorganic filler (component B) comprising an inorganic filler having an average particle diameter of 0.01 to 100 μm and a water-soluble polyester resin binder, and having a bulk density of 0.4 to 1.5 g/mL.

2. A thermoplastic resin composition according to claim 1, wherein the granular inorganic filler (component B) is a granular silicate compound.

3. A thermoplastic resin composition according to claim 1, wherein the granular inorganic filler (component B) is a granular talc.

4. A thermoplastic resin composition according to claim 1, wherein the granular inorganic filler (component B) has a particle size in which a proportion of a 500 μm-mesh screen residue thereof is not less than 55% by weight.

5. A thermoplastic resin composition according to claim 1, wherein a content of the water-soluble polyester resin binder in the granular inorganic filler (component B) is 0.1 to 3% by weight.

6. A resin molded article produced by molding the thermoplastic resin composition as defined in claim 1.
